(19) United States
(12) Patent Application Publication
(10) Pub. No.: US 2004/0254831 A1
(43) Pub. Date: Dec. 16, 2004

(54) Referral of potential customers to a seller

(76) Inventor: William C. Dean, Chesterfield, MO (US)

Correspondence Address: HARNESS, DICKEY, & PIERCE, P.L.C, 7700 BONHOMME, STE 400, ST. LOUIS, MO, 63105, US

(21) Appl. No.: 10/458,808

(22) Filed: Jun. 11, 2003

(51) Int. Cl. G06F 17/60

(52) U.S. Cl. 705/14

(57) ABSTRACT

A method, for use by a seller, of obtaining customers includes receiving a referral of a potential customer from a referral source, issuing a certificate redeemable by the potential customer for a reward upon completing a transaction with the seller, and keeping the referral source informed as to the certificate status. A seller thus can deliver status feedback to those who refer potential customers. This method can increase the efficiency and effectiveness of word-of-mouth referrals.

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyright rights whatsoever.

### BACKGROUND OF THE INVENTION

One of the most effective forms of advertising for a business can be through personal referrals by present or former customers. When a person is considering making a significant purchase, for example, the purchase of an automobile, he or she may seek information from friends and acquaintances as to their experiences in making such purchases. A recommendation made by someone known to a potential buyer can be a significant factor in the buyer's decision as to where to make the purchase. Dealers commonly encourage such referrals by offering a reward to a customer who is the “procuring cause” of another's purchase from the dealer.

The success of personal referral as an advertising medium tends to be limited, however, by the fact that word-of-mouth is ephemeral. Although a dealer may offer to pay a reward, for example, to a customer who procures another customer, it can be difficult for one making such a referral to confirm whether a reward is due from a seller on a sale to a referred customer. Likewise, it can be difficult for the seller to remember that a reward is due to the referrer.

### SUMMARY OF THE INVENTION

The present invention, in one embodiment, is directed to a method, for use by a seller, of obtaining customers. The method includes receiving a referral of a potential customer from a referral source, issuing a certificate redeemable by the potential customer for a reward upon completing a transaction with the seller, and keeping the referral source informed as to a status of the certificate.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a flow diagram of a method of obtaining customers according to one embodiment of the present invention;

FIG. 1B is a flow diagram of a method of obtaining customers according to another embodiment of the present invention;

FIG. 2 is a diagram of an embodiment of a computer system for performing a method of obtaining customers;

FIG. 3 is a flow diagram of a method of obtaining customers according to another embodiment of the present invention;

FIG. 4 illustrates an introductory screen of a seller web site in a system for performing a method of obtaining customers according to one embodiment;

FIG. 5 illustrates a “sign-up” screen of a seller web site in a system for performing a method of obtaining customers according to one embodiment;

FIG. 6 illustrates a referral screen of a seller web site in a system for performing a method of obtaining customers according to one embodiment;

FIG. 7 illustrates one embodiment of a redemption certificate;

FIG. 8 illustrates a status screen of a seller web site in a system for performing a method of obtaining customers according to one embodiment;

FIG. 9 illustrates an email to a referral source in a system for performing a method of obtaining customers according to one embodiment; and

FIG. 10 illustrates a certificate submission screen in a system for performing a method of obtaining customers according to one embodiment.

### DETAILED DESCRIPTION OF EXEMPLARY EMBODIMENTS

The following description of exemplary embodiments is merely exemplary in nature and is in no way intended to limit the invention, its application, or uses. Although embodiments of the present invention are described in connection with an automobile dealer, the invention is not so limited. Embodiments can be practiced in connection with many kinds of products and services and also in connection with purchases, leases and many other transaction types. Embodiments also are contemplated in connection with many kinds of businesses and business entities, including but not limited to sellers, dealers, lessors, lessees, individuals and companies. Thus the term “seller” includes any person or entity using an embodiment of the present invention to obtain a potential customer with respect to a transaction. A “transaction” is any type of business transaction, including but not limited to a sale, purchase and/or lease.

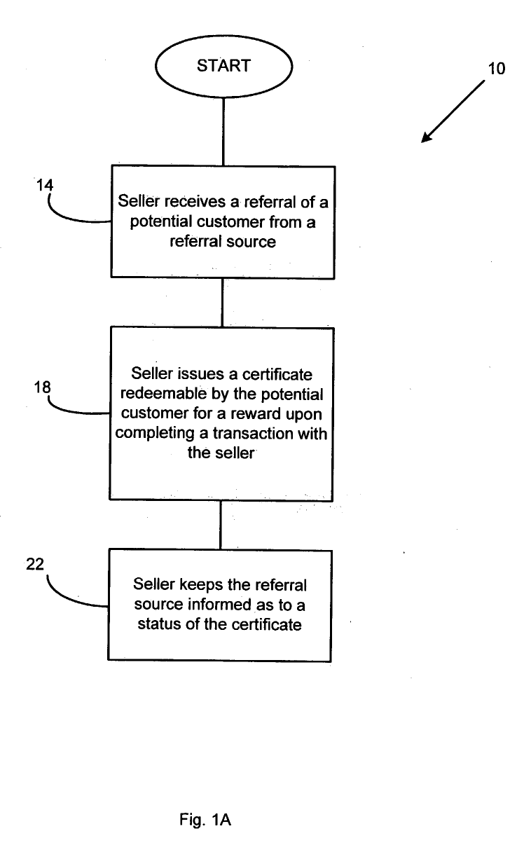

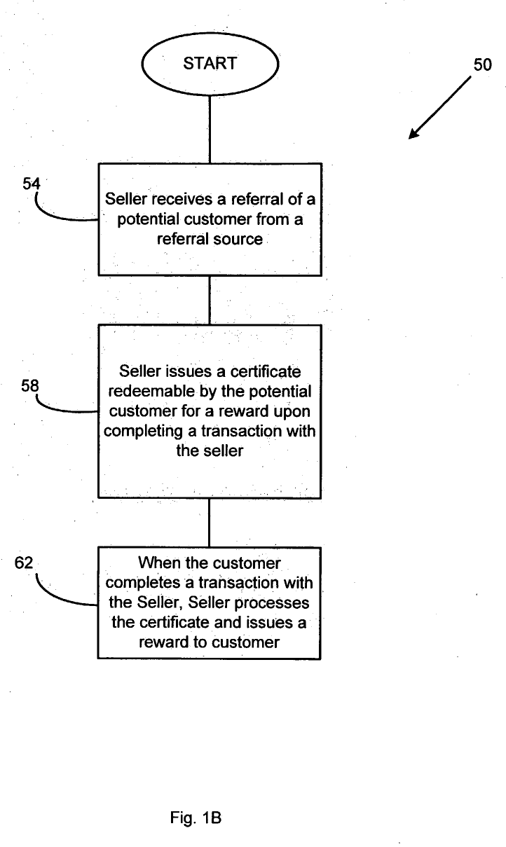

An embodiment of a method, for use by a seller, of obtaining customers is indicated generally by reference number 10 in FIG. 1A. At 14, the seller receives a referral of a potential customer from a referral source, e.g., a friend or relative of the potential customer. At 18, the seller issues a certificate redeemable by the potential customer for a reward upon completing a transaction with the seller. At 22, the seller keeps the referral source informed as to a status of the certificate. In some embodiments, the seller issues an award to the referral source and/or a reward to the potential customer when the certificate is redeemed by the potential customer.

Another embodiment of a method of obtaining customers is indicated generally by reference number 50 in FIG. 1B. At 54, the seller receives a referral of a potential customer from a referral source, e.g., a friend or relative of the potential customer. At 58, the seller issues a certificate redeemable by the potential customer for a reward upon completing a transaction with the seller. At 62, when the potential customer completes a transaction with the seller, the seller processes the certificate and issues a reward to the customer.

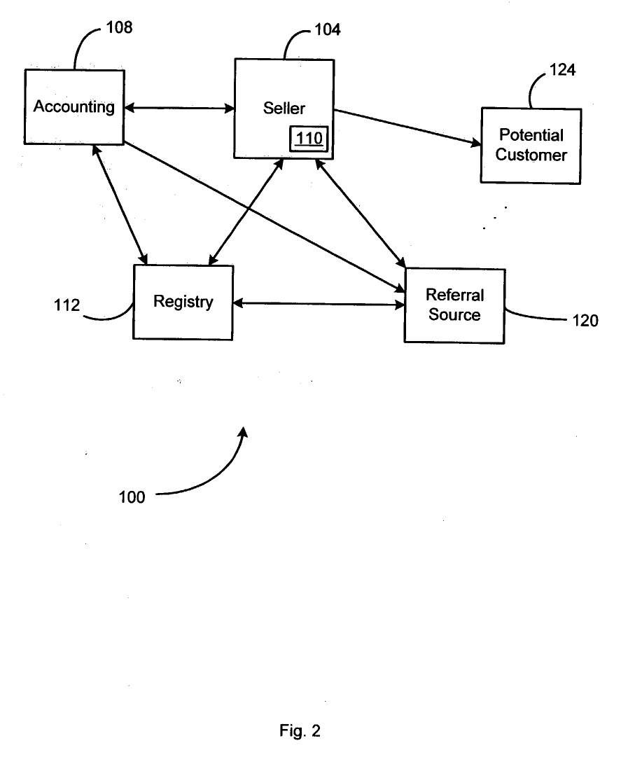

An embodiment of a computer network configured for performing the methods described with reference to FIGS. 1A and 1B is indicated generally in FIG. 2 by reference number 100. The system 100 includes a seller computer 104 and an accountant computer 108. In the system 100, the computer 104 includes a memory device 110 having instructions for performing the method under discussion. In another embodiment, a memory of another computer has such instructions. In yet another embodiment, the computer 104 and 108 are the same computer. The system 100 also includes a registry 112 for registering potential customers as further described below. The registry 112 includes one or more databases (not shown) and can reside on the computer 104, on the computer 108, and/or on a computer separate from computers 104 and 108. In another embodiment wherein the seller and accountant computers are the same computer, the registry 112 also can reside on the same computer.

It is contemplated that a plurality of sellers could use, for example, the system 100. In such an embodiment, more than one seller computer 104 could be included in the system 100 and could have access to the registry 112 as further described below.

The system 100 is configured in a computer network wherein the computers 104, 108 and a computer hosting the registry 112 (if different from computers 104 and/or 108) can be in communication with one another and with other computers accessing the network as further described below. In the embodiment shown in FIG. 2, the system 100 is configured such that computers in the system 100 can communicate with one another via the Internet.

At least one referral source computer 120, for example, a home computer of a referral source, may access the registry 112 via the Internet as further described below. The system 100 may also include one or more computers 124 of potential customer(s), also further described below.

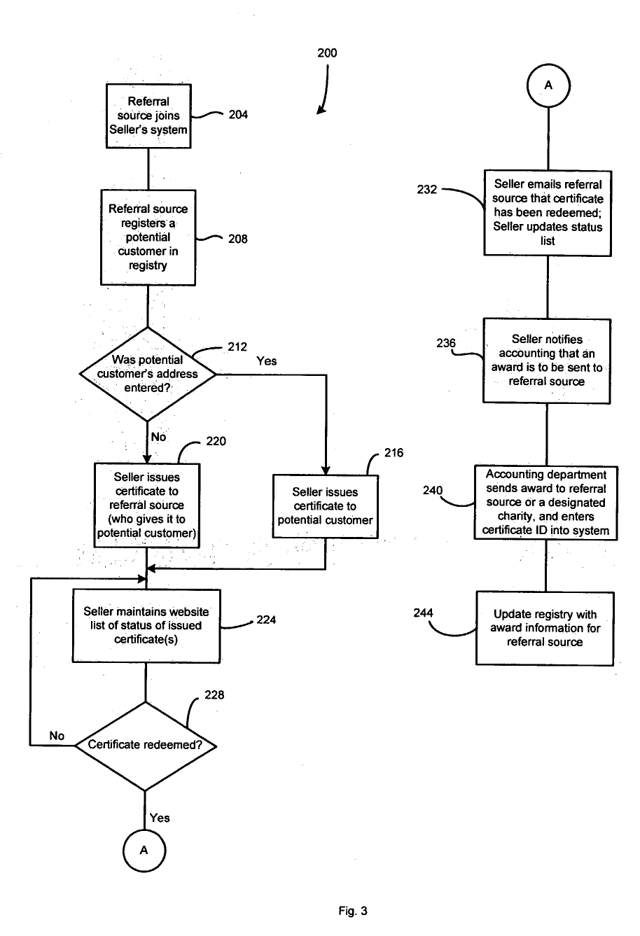

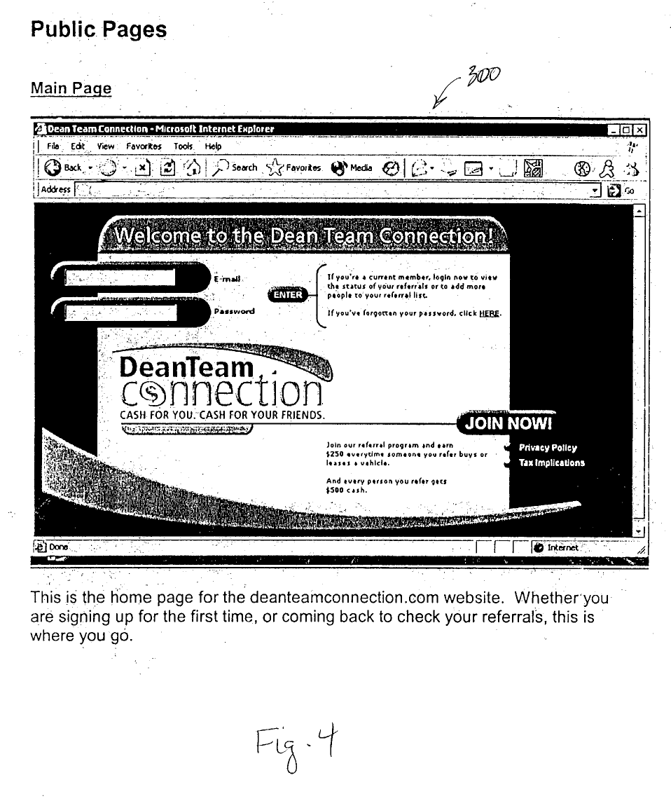

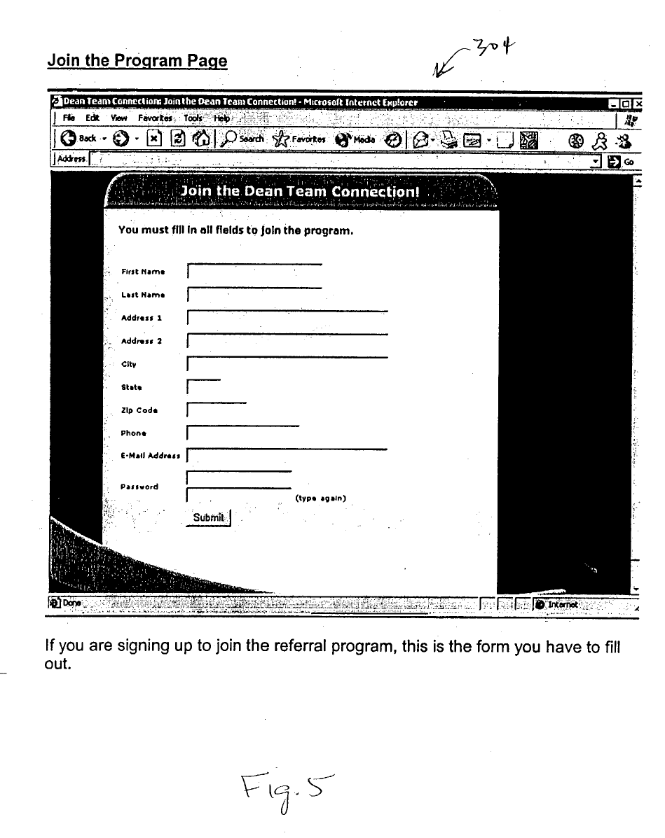

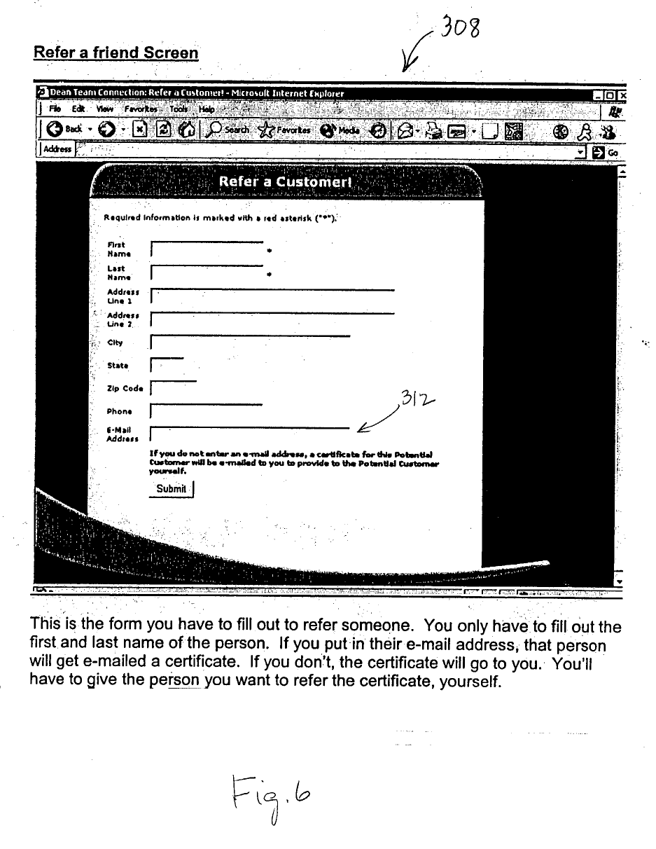

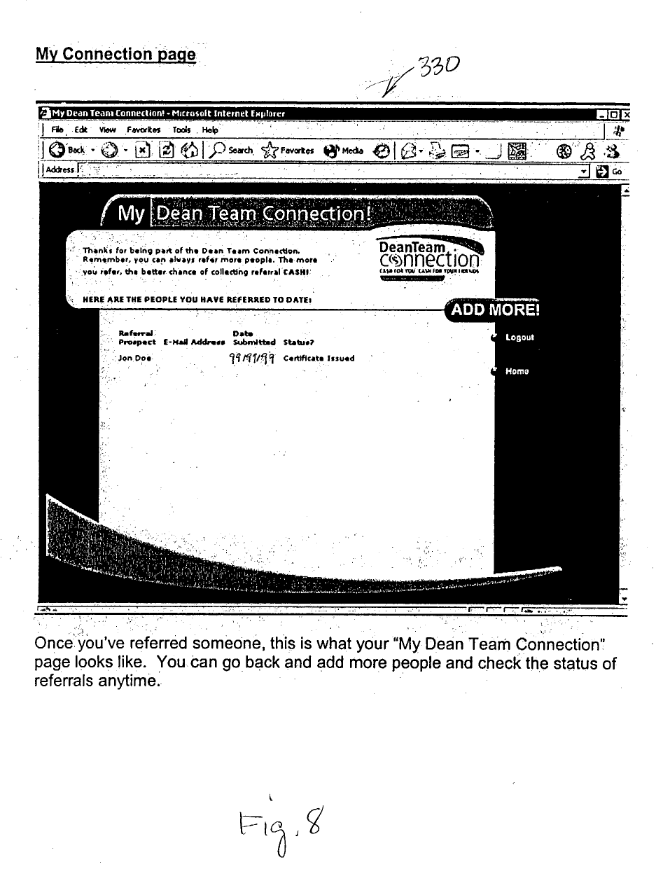

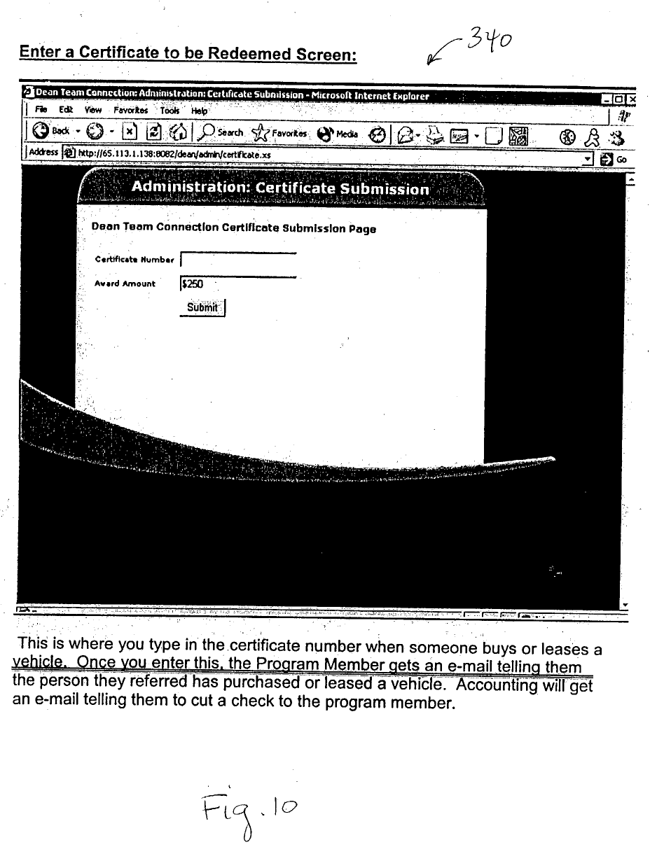

An embodiment of a method, for use by a seller, of obtaining customers is referred to generally by reference number 200 in FIG. 3 and shall be described with reference to FIGS. 2 through 10. At 204, a referral source joins the system 100 via a computer 120. Specifically, referring to FIGS. 4 and 5, the referral source connects to an Internet web site main screen 300 of the seller, clicks to a “sign-up” screen 304 and submits appropriate contact data to the seller computer 104. The system 100 maintains, e.g., in the registry 112, a list of referral sources who have joined the system 100. For each referral source, the system 100 also maintains a list of potential customers referred by that source.

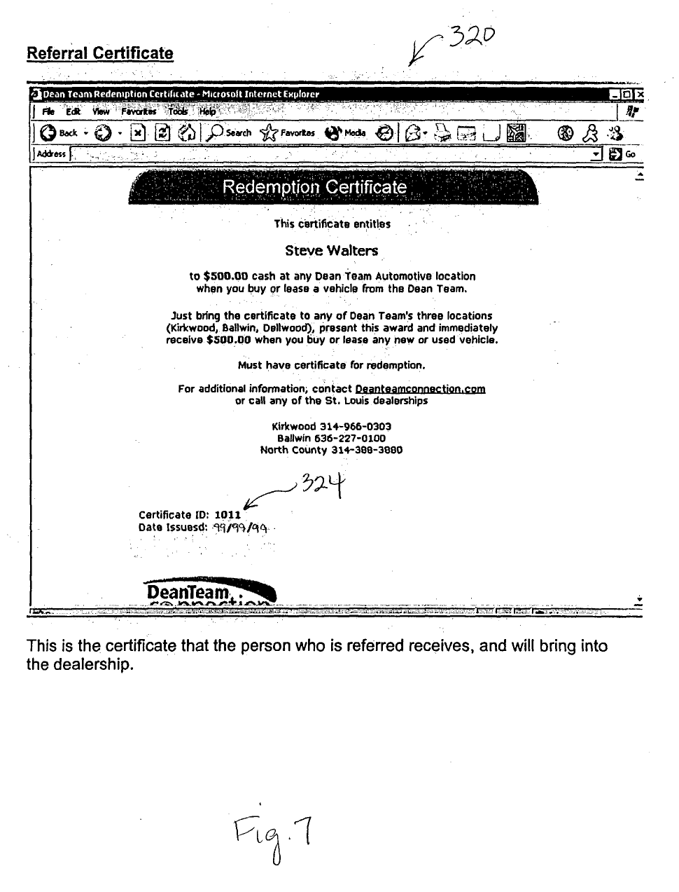

Referring to FIGS. 2, 3 and 6, the referral source registers at 208 a potential customer in the registry 112 via a referral screen 308. The referral source enters name-and-contact data for the potential customer, which may include an email address for the potential customer, e.g., on the potential customer's computer 124. If at 212 an email address was entered for the potential customer, the seller at 216 issues a certificate, indicated as 320 in FIG. 7, directly to the potential customer's email address. Otherwise the seller at 220 issues the certificate 320 to the referral source computer 120, so that the referral source can provide the certificate 320 to the potential customer.

The certificate 320 indicates that the potential customer may redeem the certificate by presenting it to the seller and completing a transaction with the seller (which, in the embodiment under discussion, includes buying or leasing a vehicle from the seller). Thus the potential customer can receive a reward from the seller upon completing such a transaction. The certificate 320 includes an identification number 324 which is used in the system 100 as further described below.

When a certificate 320 has issued to or for a potential customer, the seller at 224 posts and maintains certificate status information on a status screen 330. By connecting to the screen 330, the referral source can check on the status of any certificate(s) 320 that have issued to potential customers referred by the referral source. When at 228 a potential customer redeems a certificate and receives a reward from the seller, the seller at 232 sends an email 336 to the referral source, indicating that the potential customer has redeemed the certificate. The seller also updates the status screen 330. In this manner, the referral source is kept informed as to the status of certificate(s) issued for potential customers it referred.

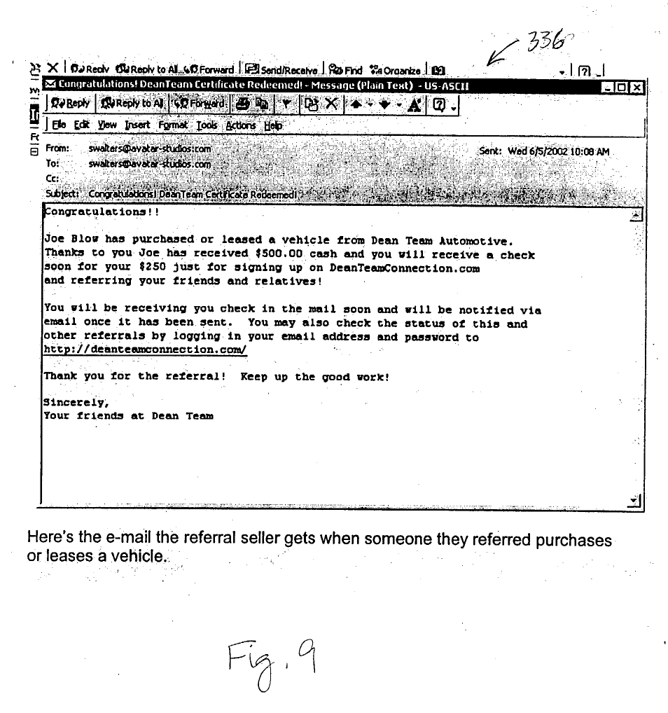

To redeem a certificate 320, the seller accesses a screen 340 and enters the certificate identification number 324 into the system 100. The seller may enter additional information, e.g., an award amount to be issued to the referral source, on the screen 340. The system 100 uses the certificate identification number 324 and other information (including, e.g., a default award amount) to generate the email 336 (shown in FIG. 9) to the referral source.

The information from the screen 340 also is used, at 236, to notify, for example, an accounting department of the seller, via accounting computer 108, that an award is to be sent to the referral source. In one embodiment, the referral source may instruct the seller to send the award to another party, for example, a charity designated by the referral source. The accounting department, for example, issues a check, at 240, to the referral source or the designated party and notifies the referral source via email that the check has issued. The certificate number 324 is entered into the system 100 to indicate that the award was issued. The system 100 at 244 updates the registry 112 list of referral sources, for example, to maintain a current tally of awards received by each referral source.

The foregoing systems and methods allow a seller to deliver status feedback to those who refer potential customers to the seller. Someone who joins the foregoing system as a referral source can be assured that his or her referral of a potential customer will be tracked and rewarded in the event that the potential customer completes a purchase from the seller. Additionally, because the potential customer receives a redeemable certificate, he or she may have additional incentive to approach the seller. Thus the foregoing systems and methods can increase the efficiency and effectiveness of word-of-mouth referrals.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method, for use by a seller, of obtaining customers, comprising:
receiving a referral of a potential customer from a referral source;
issuing a certificate redeemable by the potential customer for a reward upon completing a transaction with the seller; and
keeping the referral source informed as to a status of the certificate.

2. The method of claim 1 wherein keeping the referral source informed comprises notifying the referral source when the certificate is redeemed.

3. The method of claim 2 further comprising using the redeemed certificate to notify the referral source.

4. The method of claim 1 further comprising issuing an award to the referral source when the certificate is redeemed.

5. The method of claim 1 further comprising issuing a reward to the potential customer when the certificate is redeemed.

6. A computer system comprising at least one processor and at least one memory device having instructions for performing the method of claim 1.

7. A computer-implemented method of obtaining referrals of potential customers to a seller, comprising:
entering, in a registry of the seller, information relating to at least one potential customer submitted by a user via a computer network;
issuing a certificate, via the network, indicating that the registered potential customer is to receive a reward upon completing a transaction with the seller; and
processing the certificate and issuing a reward to the registered potential customer when the registered potential customer completes a transaction with the seller.

8. The method of claim 7 wherein processing the certificate comprises issuing an award to the user.

9. The method of claim 7 further comprising issuing the certificate to at least one of the user and the registered potential customer.

10. The method of claim 7 wherein processing the certificate comprises notifying the user that the certificate is redeemed.

11. A computer system comprising at least one processor and at least one memory device having instructions for performing the method of claim 7.

12. A computer-implemented method of referring potential customers to a seller, comprising:
receiving, from a user via a computer network, information relating to at least one potential customer;
registering, in a registry of the seller, the at least one potential customer; and
indicating, via the network to at least one of the user and the registered potential customer, that the registered potential customer is to receive a reward upon completing a transaction with the seller.

13. The method of claim 12 further comprising indicating to the user that the user is to receive an award if the registered potential customer completes a transaction with the seller.

14. The method of claim 13 further comprising the user instructing that a user award is to be issued to a charity.

15. The method of claim 12 wherein indicating that the registered potential customer is to receive a reward comprises issuing a certificate to at least one of the user and the registered potential customer.

16. The method of claim 12 further comprising sending a certificate via electronic mail to one of the user and the registered potential customer.

17. The method of claim 12 further comprising the user accessing the registry to check a status of a potential customer.

18. A computer system comprising at least one processor and at least one memory device having instructions for performing the method of claim 12.

19. A method of referring potential customers to a seller, comprising:
supplying, to the seller, information relating to a potential customer;
receiving notification that the seller is issuing a certificate indicating that the potential customer is to receive a reward upon completing a transaction with the seller; and
receiving information from the seller relating to whether the potential customer has completed a transaction.

20. The method of claim 19 further comprising receiving an award from the seller when the potential customer has completed the transaction.

21. The method of claim 19 further comprising instructing the seller to send an award to a charity when the potential customer has completed the transaction.
